(19) United States
(12) Patent Application Publication
(10) Pub. No.: US 2002/0170984 A1
(43) Pub. Date: Nov. 21, 2002

(54) Faucet having sprayer nozzle for water saving purposes

(76) Inventor: Wen Hung Tsai, Chang Hua Hsien (TW)

Correspondence Address: CHARLES E. BAXLEY, 5th Floor, 59 John Street, New York, NY, 10038, US

(21) Appl. No.: 09/859,309

(22) Filed: May 18, 2001

(51) Int. Cl. B05B 1/26

(52) U.S. Cl. 239/499; 239/504; 239/506

(57) ABSTRACT

A sprayer nozzle device includes a housing having an orifice of a reduced diameter formed in an upper plate for reducing and economizing outward flowing water. The housing includes a number of apertures formed in the lower peripheral portion for diverging and outwardly and widely spraying the water. A shield is disposed in the middle and bottom portion of the housing for shielding the middle and bottom portion of the housing, and includes a cone having a cusp directed toward the orifice of the upper plate for guiding the water to the peripheral apertures of the housing.

### BACKGROUND OF THE INVENTION

1. Field of the Invention

The present invention relates to a faucet, and more particularly to a faucet having a sprayer nozzle apparatus for water saving purposes.

2. Description of the Prior Art

Typical faucets comprise a water outlet for allowing the water to flow out of the faucets. One kind of the water pacifier has been developed for attaching onto the outlet of the faucet for pacifying the outward flowing water and for allowing the outward flowing water to flow with less noise. However, the outward flowing water may not be economized by the water pacifiers. In addition, the outward flowing water through the water outlet may be concentrated and may not be diverged or may not be widely sprayed.

The present invention has arisen to mitigate and/or obviate the afore-described disadvantages of the conventional sprayer nozzles and faucets.

### SUMMARY OF THE INVENTION

The primary objective of the present invention is to provide a faucet including a sprayer nozzle for water saving or economizing purposes.

The other objective of the present invention is to provide a faucet including a sprayer nozzle for diverging the outward flowing water or for widely spraying the outward flowing water.

The further objective of the present invention is to provide a water sprayer nozzle apparatus for attaching onto the faucets or the like and for water saving or economizing purposes.

In accordance with one aspect of the invention, there is provided a sprayer nozzle apparatus comprising a housing including an upper plate having an orifice of a reduced diameter formed therein for reducing and economizing water flowing through the upper plate of the housing, and the housing including a lower peripheral portion having a plurality of apertures formed therein for diverging and outwardly spraying the water.

The housing includes an upper portion having a peripheral shoulder formed therein, the upper plate includes an outer peripheral portion engaged on the peripheral shoulder of the housing for being supported in the upper portion of the housing.

The apertures of the housing are directed downwardly and outwardly for diverging and widely spraying the water.

The housing includes a middle and bottom portion, and means for shielding the middle and bottom portion of the housing. The shielding means includes a shield disposed in the middle and bottom portion of the housing.

The shield may be a cone disposed in the middle and bottom portion of the housing. The cone includes a cusp directed toward the orifice of the upper plate, and includes a downwardly and outwardly inclined surface for defining a peripheral space therein and for guiding the water to the apertures of the housing.

A faucet is further provided for coupling to a water reservoir and includes a water outlet, and a device is further provided for securing the housing to the faucet and includes a barrel secured to the water outlet of the faucet, and means for retaining the housing in the barrel.

The retaining means includes an inner peripheral shoulder formed in the barrel, and an outer peripheral shoulder formed in the housing and engaged with the inner peripheral shoulder of the barrel for securing the housing in the barrel.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a partial cross sectional view showing a faucet having a sprayer nozzle in accordance with the present invention;

FIG. 2 is an exploded view showing some elements of the sprayer nozzle for the faucet;

FIG. 3 is a cross sectional view of the elements of the sprayer nozzle for the faucet as shown in FIG. 2;

FIG. 4 is a bottom perspective view of the elements of the sprayer nozzle for the faucet as shown in FIGS. 2 and 3, which is disposed up-side-down;

FIG. 5 is a cross sectional view similar to FIG. 3, illustrating the other embodiment of the elements of the sprayer nozzle for the faucet as shown in FIGS. 2-4;

FIG. 6 is an exploded view similar to FIG. 2, illustrating the further embodiment of the elements of the sprayer nozzle for the faucet;

FIG. 7 is a cross sectional view of the elements of the sprayer nozzle for the faucet as shown in FIG. 6;

FIG. 8 is a bottom perspective view of the elements of the sprayer nozzle for the faucet as shown in FIGS. 6 and 7;

FIG. 9 is a partial cross sectional view similar to FIG. 1, illustrating another embodiment of the elements of the sprayer nozzle for the faucet;

FIG. 10 is an exploded view similar to FIGS. 2 and 6, illustrating the embodiment of the elements of the sprayer nozzle for the faucet as shown in FIG. 9;

FIG. 11 is a cross sectional view of the elements of the sprayer nozzle for the faucet as shown in FIG. 10; and

FIG. 12 is a bottom perspective view of the elements of the sprayer nozzle for the faucet as shown in FIGS. 10 and 11.

### DETAILED DESCRIPTION OF THE PREFERRED EMBODIMENT

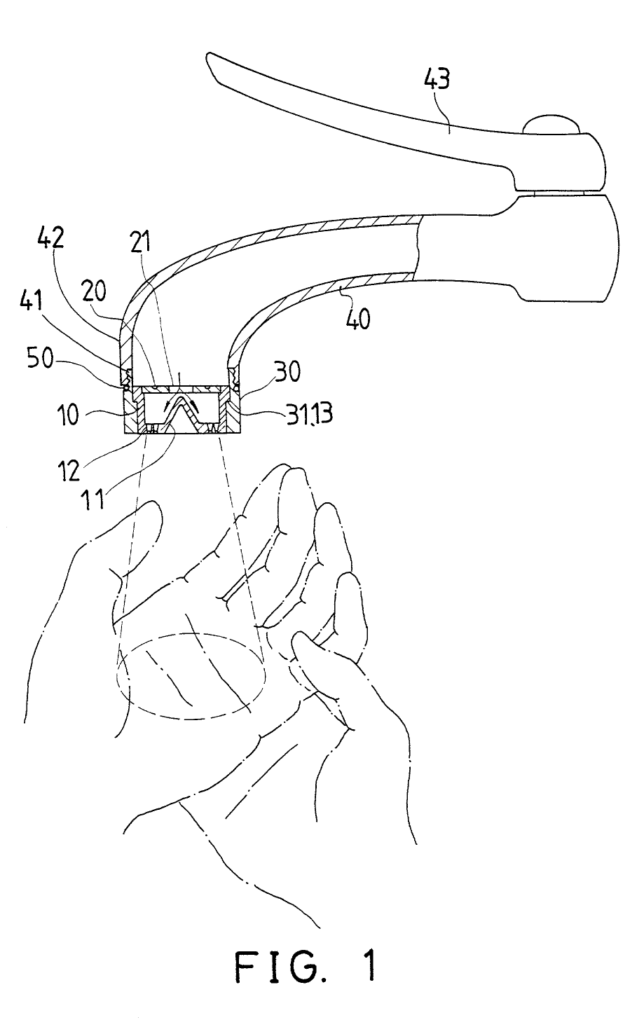

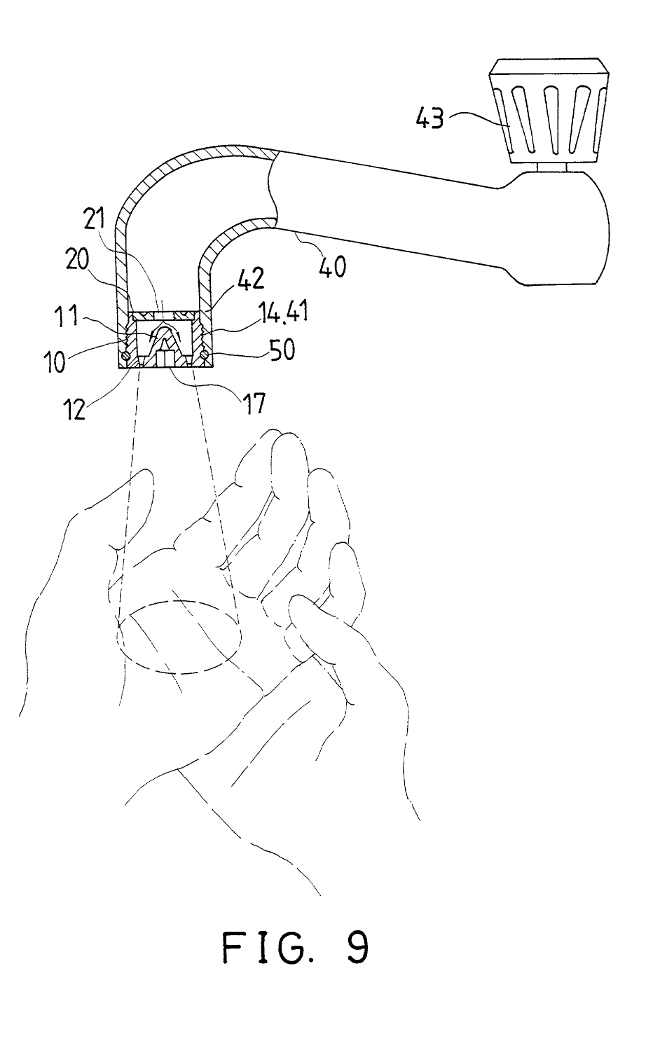

Referring to the drawings, and initially to FIG. 1, a faucet 40 in accordance with the present invention comprises an inner thread 42 formed in a water outlet 42 thereof, and a control device 43, such as a control lever (FIG. 1) or a control knob (FIG. 9) for controlling the water to flow out through the water outlet 42 of the faucet 40. A barrel 30 is secured to the water outlet 42 of the faucet 40 with an outer thread or with an adhesive material or the like, and includes a peripheral shoulder 31 formed in the inner peripheral portion thereof. A sealing ring 50 is preferably engaged between the faucet 40 and the barrel 30 for making a water tight seal between the faucet 40 and the barrel 30.

The present invention further comprises a sprayer nozzle apparatus provided for attaching or securing onto the water outlet 42 of the faucet 40 comprises a housing 10 received and engaged in the barrel 30. The housing 10 includes a peripheral flange 101 extended radially outward from the upper portion thereof for forming a peripheral shoulder 13 on the outer peripheral portion thereof and for engaging onto the peripheral shoulder 31 of the barrel 30 (FIG. 1) for allowing the housing 10 to be supported in the barrel 30.

The housing 10 includes an inner peripheral shoulder 16 formed in the inner and upper peripheral portion thereof. A plate 20 includes an outer peripheral portion engaged on the peripheral shoulder 16 of the housing 10 for allowing the plate 20 to be supported or secured on top of the housing 10. The plate 20 includes an orifice 21 formed therein and having an inner diameter less than that of the outer diameter of the plate 20; i.e., having an inner diameter less than that of the inner diameter of the barrel 30 or of the water outlet 42 of the faucet 40, such that the outward water flowing passage is reduced and such that the outward flowing water may be saved or economized.

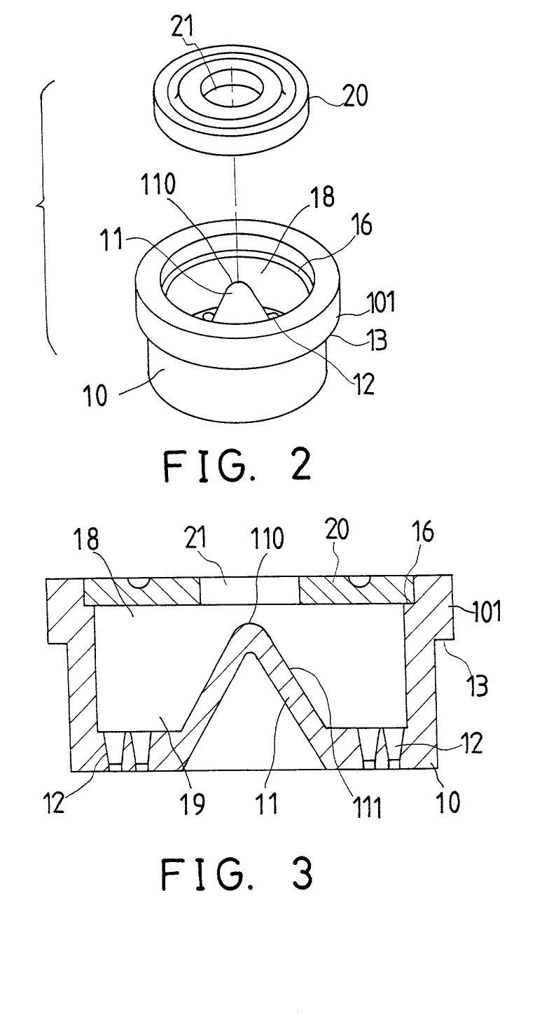

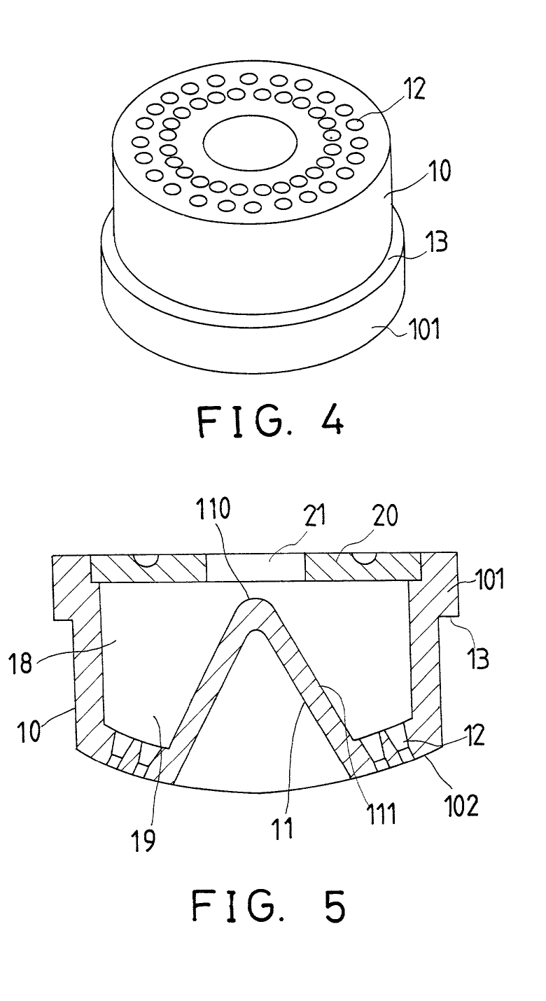

The housing 10 includes a shield 11 provided in the bottom and middle portion or in the center of the bottom portion thereof, for blocking the bottom and middle portion or in the center of the bottom portion thereof, and for forming or defining a peripheral space 19 around the shield 11. For example, as shown in FIGS. 2 and 3, the shield 11 includes a cone (11) extended inward of the hollow or inner chamber 18 of the housing 10, for forming the peripheral space 19 around the cone shaped shield 11, and thus for shielding or for blocking the bottom and middle portion or the center of the bottom portion of the housing 10.

The housing 10 includes one or more apertures 12 formed in the outer peripheral portion thereof and communicating with the peripheral space 19 thereof. The cone shaped shield 11 includes a cusp 110 extended toward the orifice 21 of the plate 20 and includes a downwardly and outwardly inclined outer surface 111 such that the water flowing through the orifice 21 of the plate 20 may thus be guided to flow along the downwardly and outwardly inclined outer surface 111 of the shield 11 and to flow out through the apertures 12 of the housing 10, best shown in FIG. 1, such that the outward flowing water may be diverged or may be widely sprayed.

Referring next to FIG. 5, the apertures 12 of the housing 10 are preferably directed downwardly and outwardly for further widely spraying the water. The housing 10 preferably includes a downwardly and outwardly inclined or tapered surface 102 formed in the bottom peripheral portion thereof, for allowing the apertures 12 of the housing 10 to be directed downwardly and outwardly and for allowing the water to be further widely sprayed outward.

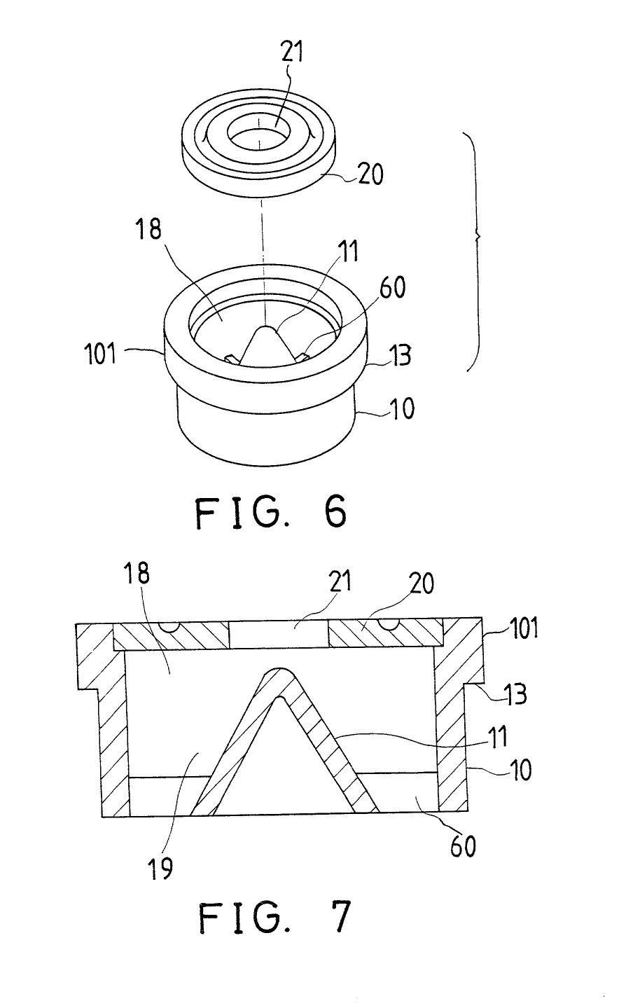

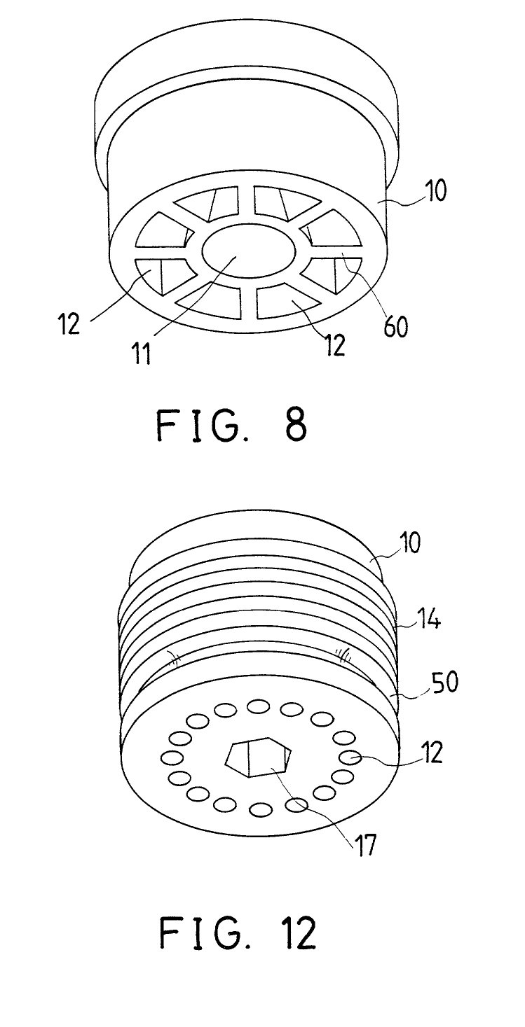

Referring next to FIGS. 6-8, the housing 10 may includes a number of radially extended ribs or panels or partitions 60 formed or provided in the outer and bottom peripheral portion thereof for forming or defining the apertures 12 of the housing 10.

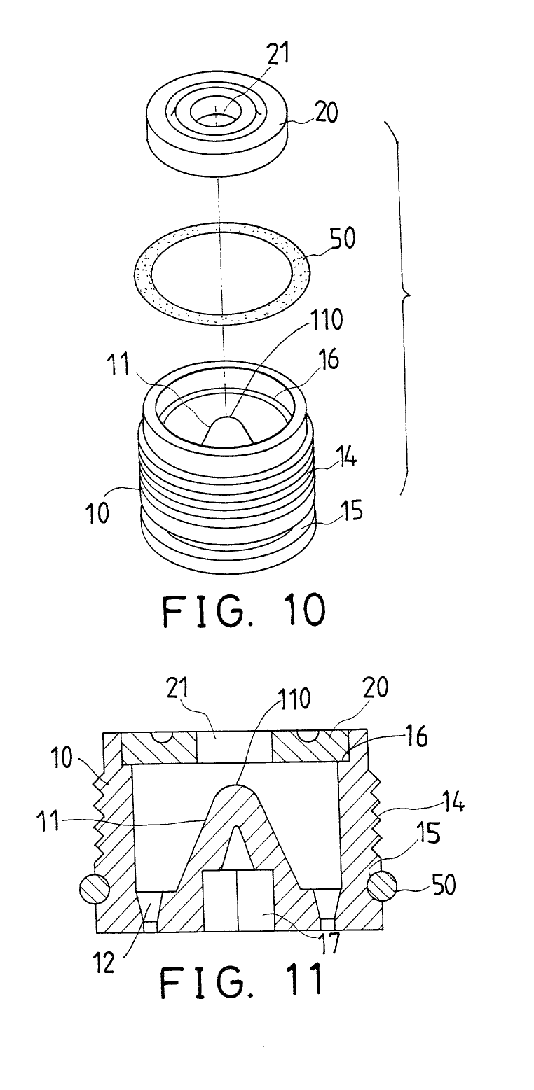

Referring next to FIGS. 9-12, the housing 10 may directly include an outer thread 14 formed or provided on the outer peripheral portion thereof for directly threading and securing to the inner thread 41 of the faucet 40 (FIG. 9). The sealing ring 50 may also be engaged between the faucet 40 and the housing 10 for making a water tight seal between the faucet 40 and the housing 10. The housing 10 includes an outer peripheral recess 15 formed in the outer peripheral portion thereof for receiving the sealing ring 50. The housing 10 includes an engaging hole, such as a hexagonal engaging hole 17 formed in the bottom thereof for engaging with a driving tool, and for allowing the housing 10 to be threaded and secured to the water outlet 42 of the faucet 40.

In operation, as shown in FIGS. 1 and 9, the water from the water reservoir may be controlled to flow out through the water outlet 42 of the faucet 40 by the control device 43. The water from the faucet 40 may flow through the orifice 21 of the plate 20 which has a reduced diameter than that of the water outlet 42 of the faucet 40, such that the outward flowing water may be saved or economized. The water may further be guided to flow along the downwardly and outwardly inclined outer surface 111 of the shield 11 and to flow out through the apertures 12 of the housing 10, such that the outward flowing water may be diverged or may be widely sprayed.

Accordingly, the faucet in accordance with the present invention includes a water sprayer nozzle apparatus attached to the water outlet thereof for water saving or economizing purposes, and for diverging the outward flowing water or for widely spraying the outward flowing water.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A sprayer nozzle apparatus comprising:
a housing including an upper plate having an orifice of a reduced diameter formed therein for reducing and economizing water flowing through said upper plate of said housing, and
said housing including a lower peripheral portion having a plurality of apertures formed therein for diverging and outwardly spraying the water.

2. The sprayer nozzle apparatus according to claim 1, wherein said housing includes an upper portion having a peripheral shoulder formed therein, said upper plate includes an outer peripheral portion engaged on said peripheral shoulder of said housing for being supported in said upper portion of said housing.

3. The sprayer nozzle apparatus according to claim 1, wherein said apertures of said housing are directed downwardly and outwardly for diverging and widely spraying the water.

4. The sprayer nozzle apparatus according to claim 1, wherein said housing includes a middle and bottom portion, and means for shielding said middle and bottom portion of said housing.

5. The sprayer nozzle apparatus according to claim 4, wherein said shielding means includes a shield disposed in said middle and bottom portion of said housing.

6. The sprayer nozzle apparatus according to claim 4, wherein said shielding means includes a cone disposed in said middle and bottom portion of said housing.

7. The sprayer nozzle apparatus according to claim 6, wherein said cone includes a cusp directed toward said orifice of said upper plate, and includes a downwardly and outwardly inclined surface for defining a peripheral space therein and for guiding the water to said apertures of said housing.

8. The sprayer nozzle apparatus according to claim 1 further comprising a faucet, and means for securing said housing to said faucet.

9. The sprayer nozzle apparatus according to claim 8, wherein said faucet includes a water outlet, said securing means includes a barrel secured to said water outlet of said faucet, and means for retaining said housing in said barrel.

10. The sprayer nozzle apparatus according to claim 9, wherein said retaining means includes an inner peripheral shoulder formed in said barrel, and an outer peripheral shoulder formed in said housing and engaged with said inner peripheral shoulder of said barrel for securing said housing in said barrel.
